(19) United States
(12) Patent Application Publication
(10) Pub. No.: US 2010/0237979 A1
(43) Pub. Date: Sep. 23, 2010

(54) FUSE BOX STRUCTURE IN SEMICONDUCTOR APPARATUS AND METHOD OF MANUFACTURING THE SAME

(76) Inventor: Jeong Guen PARK, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/494,601

(22) Filed: Jun. 30, 2009

(30) Foreign Application Priority Data
Mar. 17, 2009 (KR) 10-2009-0022555

(51) Int. Cl. H01H 85/20; H01H 69/02

(52) U.S. Cl. 337/186; 29/623

(57) ABSTRACT

A fuse box structure includes a first fuse, an insulating film formed on the first fuse, and a second fuse disposed on the insulating film to partially overlap the first fuse. Each of the first and second fuse includes a main portion and one or more cutting portions connected to the main portion. The configuration of the first and second fuse requires a reduced area of occupancy of the fuse box structure.

### CROSS-REFERENCES TO RELATED PATENT APPLICATION

The present application claims priority under 35 U.S.C 119(a) to Korean Application No. 10-2009-0022555, filed on Mar. 17, 2009, in the Korean Intellectual Property Office, which is incorporated herein by reference in its entirety as set forth in full.

### BACKGROUND

1. Technical Field

The present invention relates generally to a semiconductor apparatus and a method of manufacturing the same, and more particularly, to a fuse box structure in a semiconductor apparatus and a method of manufacturing the fuse box structure.

2. Related Art

The trend towards decreased side requires a reduction in the size of each element of a semiconductor apparatus, especially given that the number of elements included in a single semiconductor chip has largely increased. As the size of the various elements of a semiconductor apparatus decreases, the number of potential defects in a semiconductor device tends to increase causing the level of defect density to increase. An increase of defect density is a direct cause of a reduction in the yield of the semiconductor apparatus. Further, if the defect density is excessive, a wafer with semiconductor elements has to be destroyed.

To decrease the defect density, a redundancy circuit has been proposed in which defective cells are replaced by redundant cells. The redundancy circuit (or fuse circuit) can be provided for row lines (e.g. word lines) and column lines (e.g. bit lines) in a semiconductor memory apparatus and includes a plurality of fuse boxes storing address information of defective cells.

As shown in FIG. 1, a fuse box 10 is composed of a plurality of fuses 20 arranged in parallel at constant intervals P. The fuses 20 are electrically connected to row lines or column lines, and when an error occurs in the connected lines, corresponding fuses 20 are cut. Generally, the fuses 20 are cut by laser blowing. Therefore, the fuses 20 should be spaced apart from each other as much as the laser beam tolerance so that the fuses are not affected by the laser beam when adjacent fuses are cut. Reference numeral 300 indicates an open region of the fuse box in FIG. 1.

With increases in the level of integration and developments in process technology of the semiconductor apparatus, the patterns of cell regions of the semiconductor apparatus geometrically decrease in line width and gap. However, it is particularly difficult to decrease the area occupied by the fuse box to a level proportional to an increased degree of integration since the fuses 20 included in the fuse box should be necessarily spaced apart as much as the laser beam tolerance.

As such, the ratio occupied by a fuse box array in semiconductor chips has gradually increased, thereby becoming an obstacle in ensuring the effective net die of the semiconductor apparatus.

### SUMMARY

Various embodiment of the present invention include a fuse box in a semiconductor device having a structure facilitating high integration. A fuse box structure in a semiconductor apparatus according to an embodiment of the present invention includes a first fuse, an insulating film formed on the first fuse; and a second fuse disposed on the insulating film to partially overlap the first fuse.

The first fuse and the second fuse may have the same shape and the second fuse may be arranged to be rotated at a predetermined angle from a portion of the first fuse.

Further, a method of manufacturing a fuse box structure including a plurality of fuses in a semiconductor apparatus according to another embodiment of the present invention includes: providing a semiconductor substrate on which circuit elements are formed; forming a first fuse on the semiconductor substrate; forming an insulating film on the first fuse; and forming a second fuse on the insulating film.

These and other features, aspects, and embodiments are described below in the period “Detailed Description.”

### BRIEF DESCRIPTION OF THE DRAWINGS

Features, aspects, and embodiments are described in conjunction with the attached drawings, in which:

FIG. 1 is a plan view showing a fuse box structure;

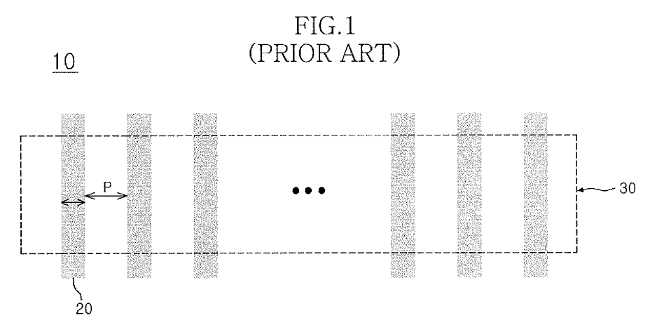

FIG. 2 is a plan view showing a fuse box according to an embodiment of the present invention;

FIGS. 3A and 3B are plan views shown for illustrating the processes of a method of manufacturing a fuse box according to an embodiment of the present invention;

FIGS. 4A and 4B are cross-sectional views shown for illustrating the processes of a method of manufacturing a fuse according to an embodiment of the present invention; and

FIGS. 5A and 5B are plan views showing a portion of a fuse box according to another embodiment of the present invention. It is understood herein that the drawings are not necessarily to scale and in some instances proportions may have been exaggerated in order to more clearly depict certain features of the invention.

### DETAILED DESCRIPTION

Hereinafter, the preferred embodiments will be described in detail with reference to the accompanying drawings.

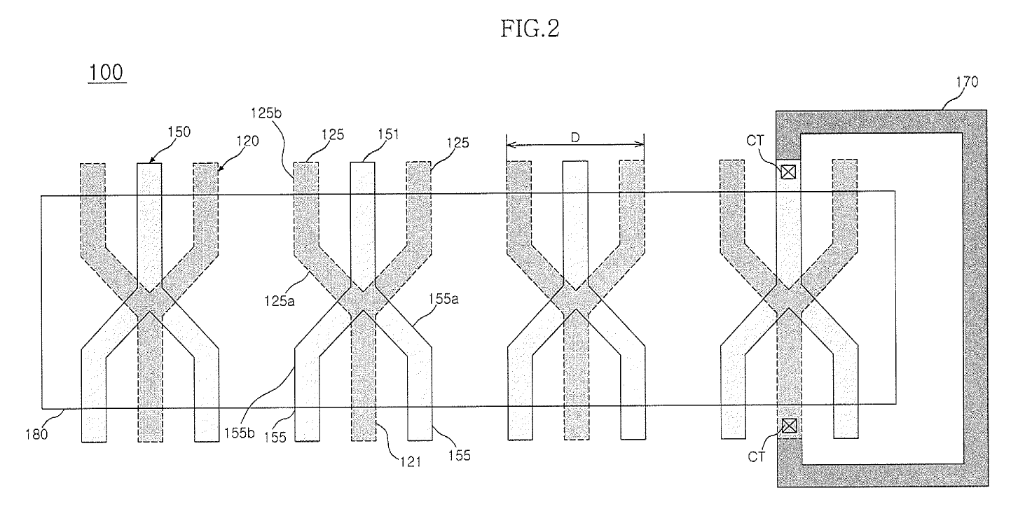

FIG. 2 is a plan view showing the structure of a fuse box according to an embodiment of the present invention.

Referring to FIG. 2, a fuse box 100 according to an embodiment includes a first fuse 120 and a second fuse 150.

In an embodiment, a plurality of the first and second fuses 120, 150 can be disposed in the space 180 defined for the fuse box. The second fuses 150 is disposed over the first fuse in manner in which the first and second fuses 120, 150 partially overlap. In an embodiment, an insulating layer (not shown) is interposed between the first and second fuses 120, 150.

In an embodiment, the first fuse 120 is rotated by a predetermined angle with respect to the second fuse 150 having the same shape as the first fuse 120, for example, 180° as shown in the embodiment of FIG. 2.

In the embodiment shown in FIG. 2, the first and second fuses each include three arms each extending from an origin in which the arms meet. In more detail, the first and second fuses 120, 150 each include main fuse portions 121, 151 and a plurality of cutting portions 125, 155 extending from the main fuse portions 121, 151. As shown in FIG. 2, the main fuse portion 151 is at one end of the first and second fuses 120, 150 and the cutting portions 125 are at the end opposite to the main fuse portion.

In an embodiment, the plurality of cutting portions 125, 155 of the first and second fuses 120, 150 respectively include diverging portions 125a, 155a and parallel portions 125b, 155b. Each of the diverging portions 125a, 155a of the fuses 120, 150 diverges a predetermined angle in order that the corresponding parallel portions 125b, 155b can be spaced at a predetermined distance D from each other. Further, first and second fuses 120, 150 may be configured in a manner in which the gap between the parallel portions 125b, 155b is the minimum gap in which the parallel portions 125b, 155b of the fuses are not influenced during laser cutting, that is, the gap may be a laser alignment tolerance of a laser beam irradiation apparatus that is used. For example, when one fuse has two cutting portions, the first and second fuses 120, 150 may have, for example, a Y-shape.

As described above, the first fuse 120 and the second fuse 150 are arranged to be rotated 180° with respect to each other in the configuration shown in FIG. 2. As a result, the main fuse portion 151 of the second fuse 150 is positioned between the cutting portions 125 of the first fuse 120 while the main fuse portion 121 of the first fuse 120 is positioned between the cutting portions 155 of the second fuse 150. Accordingly, the points at which the cutting portions 125, 155 begin to diverge in the first and second fuses 120, 150 overlap each other.

when using this configuration, the cutting portions 125 of the first fuse 120 and the main fuse portion 151 of the second fuse 150 appear as though they are disposed to have a gap between them that is less than the laser alignment tolerance when viewed in the plan view; however, it is possible to separate the cutting portions 125 of the first fuse 120 and the main fuse portion 151 of the second fuse 150 as much as the laser alignment tolerance by adjusting the thickness of the insulating layer (not shown) interposed therebetween. In an embodiment, one of the cutting portions is connected to a first row or column line and the other of the cutting portions is connected to a second row or column line. The predetermined distance D between the cutting portions is at least the minimum gap in which laser cutting of one of the cutting portions will not affect the other. Accordingly, using the configuration shown in FIG. 2, each of the first and second fuses 120, 150 may be connected to two different row or column lines.

Further, the main fuse portions 121, 151 of the first and second fuses 120, 150 can be connected with each other by a wire 170 such that the overlapped first and second fuses 120, 150 are both electrically connected to a fuse circuit portion (not shown). In this configuration, the wire 170 can be disposed to have a route at the outline of the fuse box 100 while both ends of the wire are connected to the main fuse portions 121, 151 of the first and second fuses 120 and 150. Further, the wire 170 can be disposed on the same plane as either the first fuse 120 or the second fuse 150 while being connected to the main fuse portions 121 or 151 of the fuse 120 or 150 disposed on the other layer, i.e., the layer on a different plane than that on which the wire 170 is disposed, through a contact “CT”. Reference numeral 180 indicates an open region of the fuse in FIG. 2.

As described above, the fuse box structure according to an embodiment of the present invention is configured in a manner in which the fuses having the plurality of cutting portions are stacked with the insulating layer therebetween. In this configuration, it is possible to reduce the area occupied by the fuse box structure by 50% or more when compared to fuse boxes that include straight line fuses in the related art. Accordingly, it is possible to largely reduce the fuse box array area in a semiconductor chip, making it possible to further improve the degree of integration of the semiconductor apparatus.

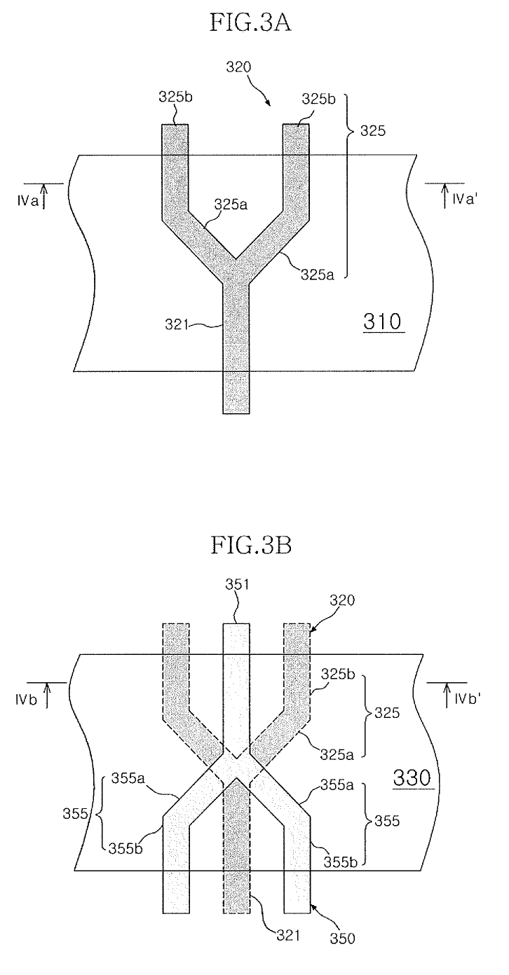

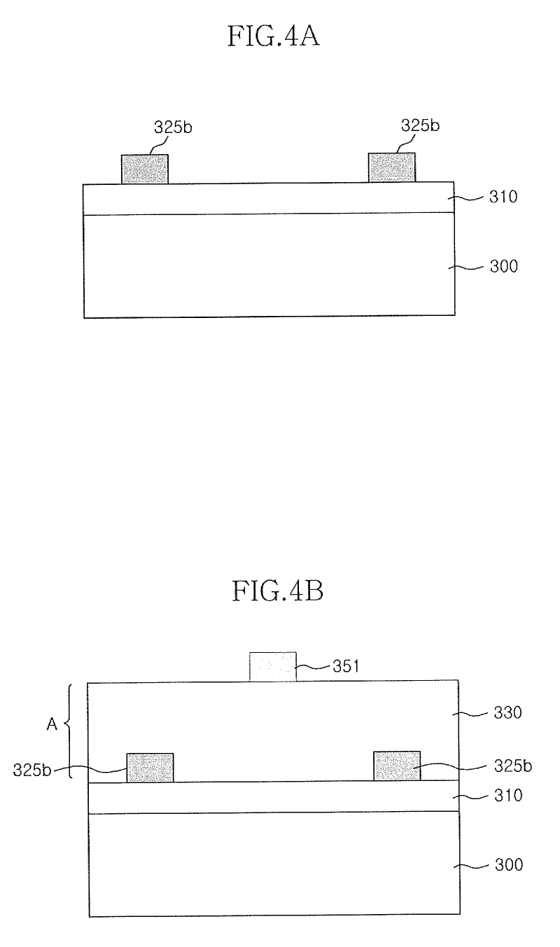

FIGS. 3A and 3B are plan views shown for illustrating processes of a method of manufacturing a fuse according to an embodiment of the present invention, and FIGS. 4A and 4B are cross-sectional views shown for illustrating the processes of the method of manufacturing a fuse according to an embodiment of the present invention. In more detail, FIG. 4A is a cross-sectional view taken along the line IVa-IVa′ of FIG. 3A, and FIG. 4B is a cross-sectional view taken along the line IVb-IVb′ of FIG. 3B.

Referring to FIGS. 3A and 4A, a first insulating film 310 is formed on a semiconductor substrate 300 having circuit elements (not shown). A first fuse portion 320 having a main fuse portion 321 and a plurality of cutting portions 325 is formed by forming a first conductive layer on the first insulating film 310 and patterning a predetermined portion of the first conductive layer. Reference numeral 325a indicates diverging portions of the cutting portions 325 and reference numeral 325b indicates parallel portions extending from the diverging portions in the figures.

Next, referring to FIGS. 3B and 4B, a second insulating film 330 is formed on the first insulating film 310 on which the first fuse 320 is formed. Examples of films that are suitable for uses as the first and second insulating films 310 and 330 include at least one of an HDP (High Density Plasma) oxide film, a PE-TEOS (Plasma Enhanced Tetra Ethyl Ortho Silicate) oxide film, an SOG (Spin On Glass) oxide film, an impurity-doped oxide film, and a silicon nitride. In an embodiment, the second insulating film 330 is formed to have a thickness ‘A’ that is in the range of, 2000 to 5000 Å to ensure a laser alignment tolerance for the first fuse 320 and a subsequently formed second fuse. Next, the second fuse 350 having the main fuse portion 351 and a plurality of cutting portions 355 is formed by forming a second conductive layer on the second insulating film 330 and patterning a predetermined portion of the second conductive layer. Reference numeral 355a indicates diverging portions of cutting portions 355 of the second fuse 350 and reference numeral 355b indicates parallel portions extending from the diverging portions 355a in the figures. In this configuration, the second conductive layer for forming the second fuse 350 may be a metal wire that is formed at the uppermost end of the semiconductor apparatus and the first conductive layer for forming the first fuse 320 may be a metal wire that is positioned right below the uppermost metal wire.

A laser array alignment tolerance is ensured for the cutting portions 325 of the first fuse 320 and the main fuse portion 351 of the second fuse 350, which are disposed adjacent to each other, by the second insulating film 330.

Thereafter, though not shown in the figures, a passivation film protecting the semiconductor apparatus is formed on the second fuse 350 and a process of opening the fuses 320 and 350 is performed.

In the existing processes of opening a fuse, the fuse is opened by etching only a predetermined portion of a passivation film. In an embodiment of the present invention, since the fuses are arranged in a plurality of layers, the first and second fuses 320 and 350 are opened by etching the second insulating film 330 as well as the passivation film.

As described in detail in the above, it is possible to reduce the area of the fuse box by 50% or more when compared to the related art, by stacking the plurality of fuses included in the fuse box with the insulating films therebetween. Therefore, it is possible to reduce the ratio of the fuse box array area in the semiconductor chip.

The present invention is not limited solely to the above embodiment.

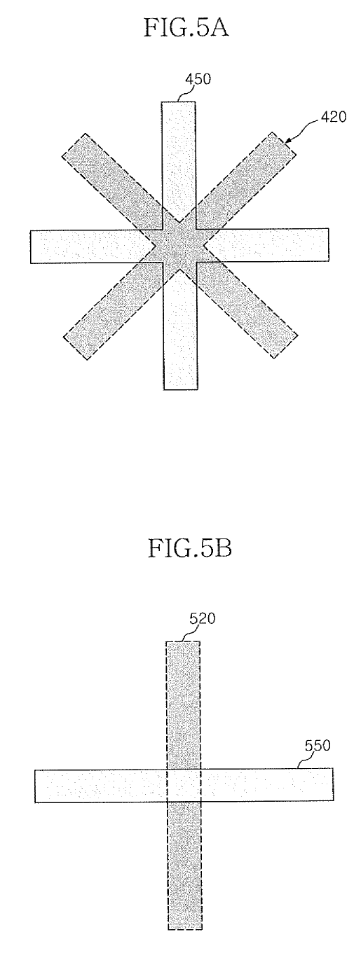

For example, although Y-shaped fuses having a plurality of cutting portions are exemplified in this embodiment, it should be understood that all structures including a fuse that is rotated at a predetermined angle with respect to another fuse while overlapping at predetermined portions, for example, X-shaped fuses 420 and 450 (see FIG. 5A) and straight line fuses 520 and 550 arranged to cross each other as shown in FIG. 5B are within the scope of the present invention. As shown in FIG. 5A, each of the X-shaped fuses has 4 arms, and the X-shaped fuse 450 is rotated by 45° with respect to the X-shaped fuse 420. Using the X-shaped fuses 410 and 450, it is possible to connect each fuse 420 and 450 to as many as three row or column lines.

Although a preferred embodiment of the present invention was described in detail, the present invention is not limited to the above embodiment and may be modified in various ways by those skilled in the art, without departing from the scope and spirit of the present invention.

What is claimed is:

1. A fuse box structure in a semiconductor apparatus, comprising:
a first fuse;
an insulating film formed on the first fuse; and
a second fuse disposed on the insulating film so as to partially overlap the first fuse.

2. The fuse box structure according to claim 1, wherein the first fuse and the second fuse have the same shape.

3. The fuse box structure according to claim 2, wherein the second fuse is arranged to be rotated a predetermined angle with respect to the first fuse.

4. The fuse box structure according to claim 1, wherein the insulating film has a thickness that is at least sufficient to ensure a laser alignment tolerance between the first fuse and the second fuse for a laser beam irradiation apparatus for cutting the first and second fuse.

5. The fuse box structure according to claim 4, wherein the thickness is in the range of 2000 to 5000 Å.

6. The fuse box structure according to claim 1, further comprising a wire electrically connecting a portion of the first fuse to a portion of the second fuse.

7. The fuse box structure according to claim 1, wherein the first and second fuses have a plurality of cutting portions.

8. The fuse box structure according to claim 7, wherein a portion of the plurality of cutting portions are spaced apart from each other at least as much as a laser alignment tolerance.

9. The fuse box structure according to claim 7, wherein the first and second fuses each further comprises a main portion connected to the plurality of cutting portions, wherein the plurality of cutting portions and the main portion each extend from an origin and each of the plurality of cutting portions is electrically connected to a different row or column line.

10. The fuse box structure according to claim 7, wherein the first and second fuses each further comprises a main fuse portion connected to the plurality of cutting portions, and
the plurality of cutting portions each have first and second diverging portions that diverge at a predetermined angle from the main fuse portion and first and second parallel portions that extend in parallel with each other from the first and second diverging portions.

11. The fuse box structure in a semiconductor apparatus according to claim 10, wherein the first and second parallel portions are spaced apart from each other as much as a laser alignment tolerance.

12. A method of manufacturing a fuse box structure including a plurality of fuses in a semiconductor apparatus, the method comprising:
providing a semiconductor substrate on which circuit elements are formed;
forming a first fuse on the semiconductor substrate;
forming an insulating film on the first fuse; and
forming a second fuse on the insulating film so as to overlap the first fuse.

13. The method according to claim 12, wherein the forming of the first fuse comprises:
forming a first conductive layer on the semiconductor substrate; and
patterning a predetermined portion of the first conductive layer.

14. The method according to claim 13, wherein the forming of the second fuse comprises:
forming a second conductive layer on the insulating film; and
patterning a predetermined portion of the second conductive layer.

15. The method according to claim 14, wherein the second conductive layer is a metal film and is formed at the uppermost portion of the semiconductor apparatus.

16. The method according to claim 12, further comprising:
opening the first and second fuses after the forming of the second fuse.
